(19) United States
(12) Patent Application Publication
(10) Pub. No.: US 2023/0235793 A1
(43) Pub. Date: Jul. 27, 2023

(54) TORSIONAL-RADIAL MECHANICAL COUPLING FOR THEATRICAL WIRE ROPE HOIST

(71) Applicant: Wenger Corporation, Owatonna, MN (US)

(72) Inventor: Peter V. Svitavsky, Port Byron, NY (US)

(21) Appl. No.: 18/160,153

(22) Filed: Jan. 26, 2023

Related U.S. Application Data
(60) Provisional application No. 63/303,257, filed on Jan. 26, 2022.

(51) Int. Cl. F16D 1/10; B66D 1/14; A63J 1/02

(52) U.S. Cl. CPC F16D 1/101; B66D 1/14; A63J 1/028; F16D 2001/102; F16D 2300/08

(57) ABSTRACT

A mechanical coupling for use with a theatrical hoist including a shaft having a body portion and a head portion defining an external hexagonal end with flanked surfaces in a plane parallel to and radial with a centerline of the mechanical coupling, and a liner including an internal hexagonal end corresponding to the external hexagonal end of the shaft. The flanked surfaces of the external hexagonal end are configured to engage with the internal hexagonal end of the liner. The mechanical coupling enables transmission of a moment about an x-axis of the mechanical coupling and enables transmission of forces along a y-axis and a z-axis of the mechanical coupling. The mechanical coupling inhibits transmission of moments about the y-axis and the z-axis of the mechanical coupling and inhibits transmission of forces along the x-axis.

### CROSS-REFERENCE TO RELATED APPLICATION

The present application claims the benefit of U.S. Provisional Application No. 63/303,257, filed Jan. 26, 2022, which is hereby incorporated herein by reference in its entirety.

### TECHNICAL FIELD

The present disclosure relates to theatrical wire rope hoists. In particular, the present disclosure relates to a theatrical wire rope hoist having a torsional-radial mechanical coupling.

### BACKGROUND

It is common practice for performance theatres to use a hoist for raising and lowering stage equipment including curtains, lights, and scenery, as well as to effect horizontal movement of stage equipment across a stage. Examples of conventional theatrical hoists and hoist systems include U.S. Pat. Nos. 7,766,308 and 8,328,165, the disclosures of which are incorporated herein by reference in their entireties.

Theatrical hoists must satisfy rigorous safety standards because loads are being lifted and carried directly over humans. As a result, theaters occasionally use several hoists working together simultaneously in a system (i.e., a rigging system) to satisfy the heightened safety requirements. In addition to addressing safety concerns, hoists serve several functions in a theatrical setting including increased access to stage equipment, enhanced dramatic effect during performances, and masking of stage equipment from audience view. These functions are specific to theatres and generally not required for hoists used in other settings such as construction, architectural, and industrial applications.

Theatrical hoists allow a stage operator to raise and lower items such as lighting elements, props, and other onstage equipment for adjustment, replacement of parts, and/or to conduct essential routine maintenance. For example, lighting elements are frequently moved and altered (e.g., changing the light color) to meet the requirements of individual performances. Movement and adjustment of lighting elements is most easily and safely performed when they are brought to the floor level rather than at an elevation where a ladder is required which can create an unnecessary safety concern. This is especially true considering the short time frames between scene changes in a stage performance which is typically when a stage operator moves and/or adjusts the lighting elements.

For some theaters, hoists are primarily used to move stage scenery for dramatic effect during a performance. A well-designed rigging system comprised of one or more hoists enables simple scene changes to actively occur during live performances. Many performances use scenery moving in view of the audience, creating added impact that becomes a key part of the production and enhances the quality of the show. Hoists provide mechanical advantage which makes moving scenery appear more dynamic to the viewer while also significantly reducing the amount of manual stage adjustment required by the operators.

Another important aspect of a stage performance is the seamless transition between scenes without the audience seeing or hearing the equipment involved in the transitions. For example, curtains are used to frame the visual picture as well as to mask the changing of stage equipment and sceneries from audience view. This “frame” can change to meet the requirements of specific productions, requirements that can be achieved quickly and easily using a theatrical hoist.

Conventional theatrical hoists commonly utilize, among other components, a motorized drum for reeling in the rope, wire, or cable used for the lifting and lowering of items, a shaft connecting the drum to the output shaft of a gear reducer positioned adjacent the drum, and a mechanical coupling that connects the drum to the output shaft. Motorized hoists, as compared to manually operated hoists, enable dramatic scene transitions to be programmed using simple control systems which provide the assurance of predictable, consistent scenery movements for each stage performance.

One issue with conventional motorized hoists is the unintended transmission of forces and moments across the mechanical coupling between the reducer output shaft and the drum. This can cause unpredictable stresses and motion that compromise the durability and functionality of the hoist while also creating a noise nuisance during a stage performance due to excessive mechanical vibration. Existing mechanical couplings, which generally incorporate hardened rolling elements such as balls or cylindrical rollers, cannot adequately address the issue of excessive mechanical vibration because their allowable speed and duty cycle capacity typically exceed the performance requirements of wire rope hoists, making their larger physical size and cost impractical for use.

### SUMMARY

The present inventors have identified a need for a mechanical coupling designed to transmit only specific torsional and radial loads from the reducer output shaft to the drum, while also decoupling the forces and moments corresponding to the remaining degrees of freedom of the mechanical coupling. The present inventors have further identified solutions to this need which lessen unwanted stresses and motion in the hoist thereby reducing noise generation and physical degradation due to mechanical vibration. Various embodiments of systems, devices, and methods implementing these solutions are described herein.

In embodiments, a theatrical wire rope hoist includes a reducer output shaft, a drum configured to rotate in response to the reducer output shaft, and a mechanical coupling connecting the reducer output shaft and the drum, the mechanical coupling including a shaft defining a body portion and a head portion with an external hexagonal end having flanked surfaces in a plane parallel to and radial with a centerline of the mechanical coupling, and a liner including an internal hexagonal end corresponding to the external hexagonal end of the shaft. The flanked surfaces of the external hexagonal end of the shaft portion are configured to engage with the internal hexagonal end of the liner. The mechanical coupling enables transmission of a moment about an x-axis of the mechanical coupling thereby causing the drum to rotate, and enables transmission of forces along a y-axis and a z-axis of the mechanical coupling. The mechanical coupling inhibits transmission of moments about the y-axis and the z-axis of the mechanical coupling and inhibits transmission of forces along the x-axis of the mechanical coupling.

In embodiments, a mechanical coupling for use with a theatrical wire rope hoist includes a shaft having a body portion and a head portion defining an external hexagonal end with flanked surfaces in a plane parallel to and radial with a centerline of the mechanical coupling, and a liner including an internal hexagonal end corresponding to the external hexagonal end of the shaft. The flanked surfaces of the external hexagonal end are configured to engage with the internal hexagonal end of the liner. The mechanical coupling enables transmission of a moment about an x-axis of the mechanical coupling and enables transmission of forces along a y-axis and a z-axis of the mechanical coupling. The mechanical coupling inhibits transmission of moments about the y-axis and the z-axis of the mechanical coupling and inhibits transmission of forces along the z-axis of the mechanical coupling.

In embodiments, a mechanical coupling for use with a theatrical wire rope hoist includes a shaft having a body portion and a head portion defining an external hexagonal end with flanked surfaces in a plane parallel to and radial with a centerline of the mechanical coupling. The theatrical wire rope hoist includes a drum having an internal hexagonal end, and the flanked surfaces of the external hexagonal end are configured to engage with the internal hexagonal end of the drum. The mechanical coupling enables transmission of a moment about an x-axis of the mechanical coupling thereby causing the drum to rotate, and enables transmission of forces along a y-axis and a z-axis of the mechanical coupling. The mechanical coupling inhibits transmission of moments about the y-axis and the z-axis of the mechanical coupling and inhibits transmission of forces along the z-axis of the mechanical coupling.

In embodiments, a mechanical coupling for use with a theatrical wire rope hoist includes a head portion defining an external hexagonal end with flanked surfaces in a plane parallel to and radial with a centerline of the mechanical coupling, and a liner including an internal hexagonal end configured to engage with the external hexagonal end of the head portion. The flanked surfaces of the external hexagonal end are configured to engage with the internal hexagonal end of the liner. The mechanical coupling enables transmission of a moment about an x-axis of the mechanical coupling and enables transmission of forces along a y-axis and a z-axis of the mechanical coupling. The mechanical coupling inhibits transmission of moments about the y-axis and the z-axis of the mechanical coupling and inhibits transmission of forces along the z-axis of the mechanical coupling.

In embodiments, moments about the y-axis and the z-axis enable sliding contact between the flanked surfaces of the external hexagonal end and the internal hexagonal end of the liner. In embodiments, the flanked surfaces each have a radius between about 9 and 10 millimeters. In embodiments, the flanked surfaces each have a radius between about 9.30 and 9.40 millimeters. In embodiments, the flanked surfaces are each a prismatic approximation of a curve. In embodiments, the body portion of the mechanical coupling includes a slotted relief surface on a surface parallel with a top plane of the body portion. In embodiments, the head portion of the mechanical coupling includes an O-ring groove that follows an outer contour of the external hexagonal end.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

FIG. 1 is a depiction of a conventional rigging system for use in a theatrical setting.

FIG. 2 is an isometric view of a theatrical wire rope hoist, according to an embodiment of the disclosure.

FIGS. 3 and 4 are sectional views of a theatrical wire rope hoist including a mechanical coupling, according to embodiments of the disclosure.

FIG. 5 is a top plan view of a shaft of a mechanical coupling, according to an embodiment of the disclosure.

FIG. 6 is a side plan view of a shaft of a mechanical coupling, according to an embodiment of the disclosure.

FIG. 7 is a front plan view of a shaft of a mechanical coupling, according to an embodiment of the disclosure.

FIG. 8 is a back plan view of a shaft of a mechanical coupling, according to an embodiment of the disclosure.

FIG. 9 is a sectional front view of a shaft of a mechanical coupling, according to an embodiment of the disclosure.

FIG. 10 is an elevation view of a theatrical wire rope hoist in operation, according to an embodiment of the disclosure.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION OF THE DRAWINGS

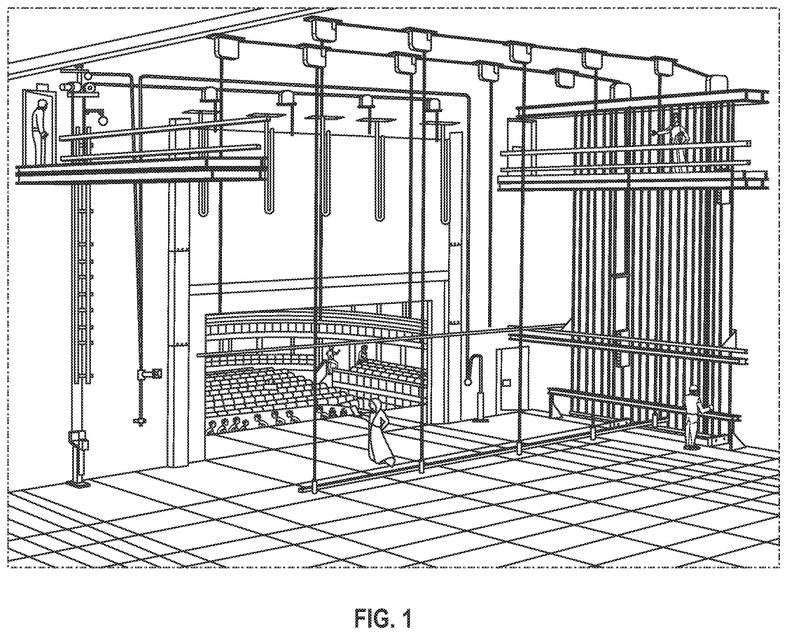

Referring to FIG. 1, a conventional rigging system employing a conventional wire rope hoist hung from a wall is shown in a theatrical setting. Together with several loft blocks hung from the ceiling, the wire rope hoist facilitates lifting and lowering of theatrical equipment such as curtains, lights, or stage scenery. As noted previously, the wire rope hoist typically operates above humans which creates a potential safety concern if not adequately designed. One potential safety concern is unwanted stresses and motion inside the hoist which can initiate uncontrolled vibration followed by destabilization of internal parts ultimately resulting in hoist failure. If at the time of failure the hoist is either lifting or lowering an item and there is human located underneath, the item may fall on top of the human causing injury or potentially death. As such, it is critical to design hoists in a way that minimizes the possibility of unwanted vibration caused by internal stresses and motions.

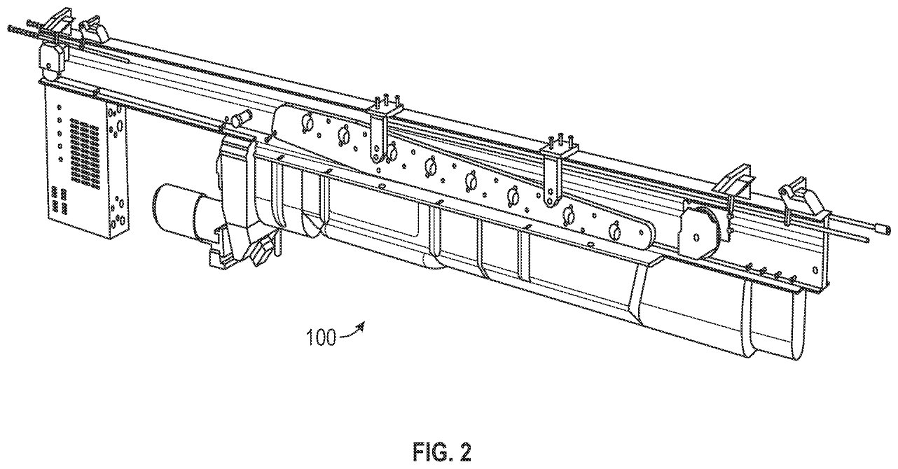

Referring generally to FIGS. 2 and 3, a theatrical wire rope hoist 100 according to an embodiment of the disclosure may comprise a gear reducer 110 having a reducer output shaft 114, a drum 120 having wire ropes and being configured to rotate in response to the reducer output shaft 114, a drum brake (not depicted) configured to slow and stop the theatrical wire rope hoist 100, a motor assembly (not depicted) configured to drive the drum 120 to rotate, a controller module (not depicted) configured to send control signals, a motor brake (not depicted) configured to receive one or more control signals from the controller module and to brake the rotation of the motor assembly upon receipt of the one or more control signals, and a mechanical coupling 130 connecting the reducer output shaft 114 and the drum 120 together. Mechanical coupling 130 effects transfer of only specific torsional and radial loads from the reducer output shaft 114 to the drum 120 (i.e., forces along a y-axis and a z-axis and moments about an x-axis of the mechanical coupling), while decoupling the forces and moments corresponding to the remaining degrees of freedom associated with mechanical coupling 130 (i.e., forces along the x-axis and moments about the y-axis and the z-axis of the mechanical coupling).

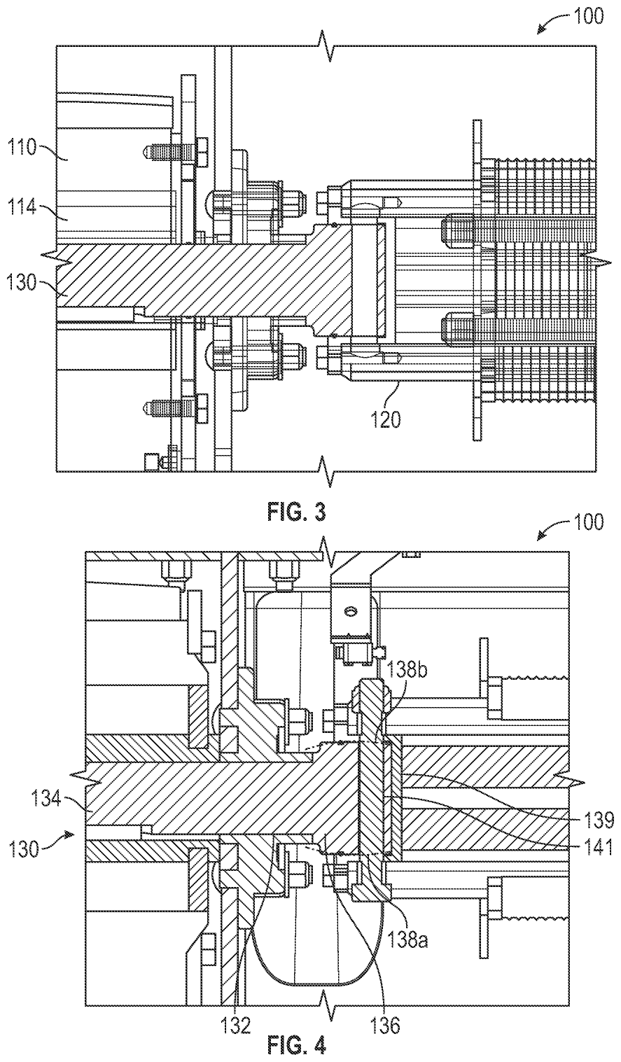

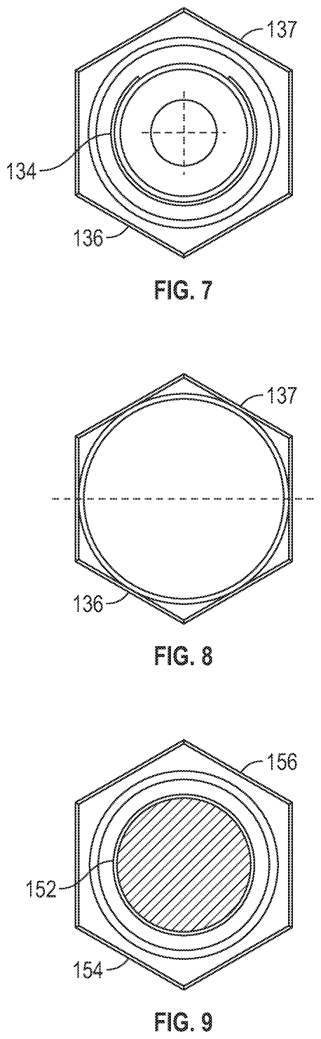

Referring generally to FIGS. 4-9, a mechanical coupling 130 according to an embodiment of the disclosure may comprise a shaft 132 including a body portion 134 connected to a head portion 136, the head portion 136 having an external hexagonal end 137 with flanked surfaces 138a,b in a plane parallel and radial to a centerline C of the mechanical coupling 150, and a liner 139 including an internal hexagonal end 141 corresponding to the external hexagonal end 137 of the shaft 132. A radius of flanked surfaces 138a,b is generally small enough to accommodate the anticipated angular misalignment between the drum 120 and the reducer output shaft 114 thus increasing the contact area between the shaft 132 and the liner 139. Mechanical coupling 130 is generally made from a hardened material such as steel or a softer material such as plastic, though other materials may be used during manufacturing.

In embodiments, flanked surfaces 138a,b can have a radius in the range of about 9 to 10 millimeters, or more specifically in the range of about 9.30 and 9.40 millimeters. In other embodiments, flanked surfaces 138a,b may have a geometry corresponding to a prismatic approximation of a curve. Flanked surfaces 138a,b are configured to engage with the internal hexagonal end 141 of liner 139 which corresponds to the external hexagonal end 137 of shaft 132. In embodiments, flanked surfaces 138a,b are configured to engage with a corresponding internal hexagonal end, or internal hexagonal features, defined within drum 120 itself.

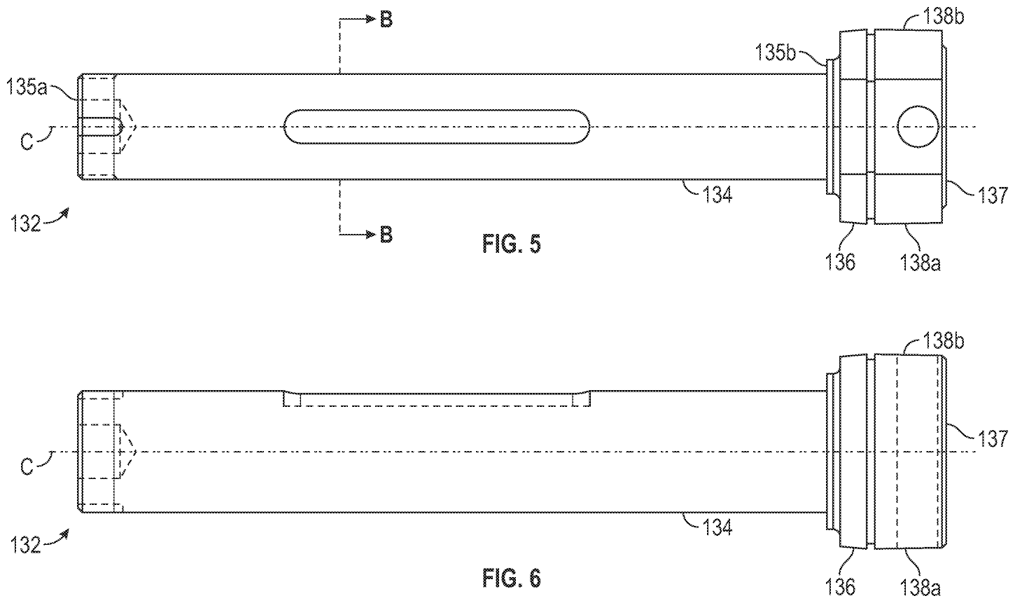

Body portion 134 of shaft 132 can be formed as an elongated cylindrical column with a slotted relief surface included on a surface parallel with a top plane of body portion 134. Other geometrical configurations including, but not limited to, a cuboid, a pentagonal prism, and a triangular prism are contemplated for body portion 134. As shown in FIGS. 5 and 6, body portion 134 may include a chamfer at a first end 135a and a filleted surface at a second end 135b, or vice versa. A tapped thread may be included through a cross section of body portion 134 at first end 135a. As shown in FIGS. 5 and 6, head portion 136 may include a milled O-ring groove that follows an outer contour of the external hexagonal end 137 with a constant depth. Head portion 136 may include a chamfer at external hexagonal end 137 which does not form any part of flanked surfaces 138a,b. Head portion 136 may also include a through cut bore for receiving a hoist shaft located internally within theatrical wire rope hoist 100.

In operation, a moment about an x-axis of mechanical coupling 130 creates contact between the flanked surfaces 138a,b of external hexagonal end 137 and the internal hexagonal end 141 of liner 139. This enables torque transmission to rotate drum 120 which in turn initiates lifting or lowering of an item by theatrical wire rope hoist 100. Furthermore, the reaction forces present at an end of drum 120 are resisted because of a corresponding load on the wire ropes. Concurrently, moments about a y-axis and a z-axis of the mechanical coupling 130 create sliding contact between the flanked surfaces 138a,b of external hexagonal end 137 and the internal hexagonal end 141 of liner 139 causing transfer of negligible forces from these components. Accordingly, mechanical coupling 130 effectuates transfer of only the forces and moments necessary to support and rotate the drum 120 of the theatrical wire rope hoist 100 to lift and lower stage equipment. This reduces unwanted stresses and motion in the theatrical wire rope hoist 100 thereby reducing noise generation and physical degradation due to excessive mechanical vibration.

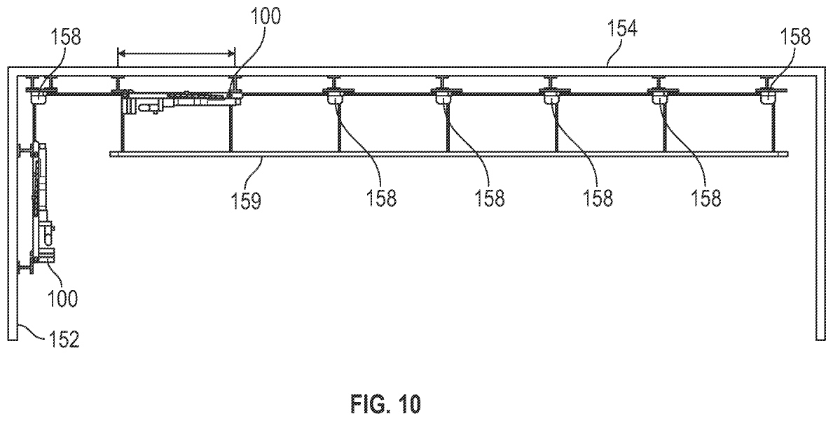

Referring to FIG. 10, theatrical wire rope hoist 100 is generally attached to a side wall 152 or a ceiling 154 of a theatre stage, though attachment points at ground-level are contemplated. Theatrical wire rope hoist 100 is configured to connect via rope wire with one or more loft blocks 158 attached to the ceiling 154 to allow lifting and lowering of stage equipment 159.

The solutions and designs disclosed herein of a theatrical wire rope hoist 100 using a mechanical coupling 130 rely on fewer and simpler parts compared to conventional theatrical hoists. The geometric features required to accommodate mechanical coupling 130 are incorporated directly into the reducer output shaft 114 and the drum 120 thus eliminating the need for additional parts. The relatively small motions between mechanical coupling 130, reducer output shaft 114, and drum 120 necessary to release the desired degrees of freedom are accomplished by sliding motion rather than rolling motion. This creates a more compact design with the allowable loads and durability of the mechanical coupling 130 being dictated by the capacity of the unhardened materials to tolerate sliding motion. The result is a more cost-effective theatrical wire rope hoist 100 with duty cycle capacity and durability optimized for limits of use in a theatrical setting.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

For purposes of interpreting the claims, it is expressly intended that the provisions of 35 U.S.C. § 112(f) are not to be invoked unless the specific terms “means for” or “step for” are recited in a claim.

1. A theatrical wire rope hoist, comprising:
a reducer output shaft;
a drum configured to rotate in response to the reducer output shaft; and
a mechanical coupling connecting the reducer output shaft and the drum, the mechanical coupling including a shaft defining a body portion and a head portion with an external hexagonal end having flanked surfaces in a plane parallel to and radial with a centerline of the mechanical coupling, and a liner including an internal hexagonal end corresponding to the external hexagonal end of the shaft,
wherein the flanked surfaces of the external hexagonal end of the shaft portion are configured to engage with the internal hexagonal end of the liner,
wherein the mechanical coupling enables transmission of a moment about an x-axis of the mechanical coupling thereby causing the drum to rotate, and enables transmission of forces along a y-axis and a z-axis of the mechanical coupling, and
wherein the mechanical coupling inhibits transmission of moments about the y-axis and the z-axis of the mechanical coupling and inhibits transmission of forces along the x-axis of the mechanical coupling.

2. The theatrical wire rope hoist of claim 1, wherein moments about the y-axis and the z-axis of the mechanical coupling enable sliding contact between the flanked surfaces of the external hexagonal end and the internal hexagonal end of the liner.

3. The theatrical wire rope hoist of claim 1, wherein the flanked surfaces of the mechanical coupling each have a radius between about 9 and 10 millimeters.

4. The theatrical wire rope hoist of claim 1, wherein the flanked surfaces of the mechanical coupling each have a radius between about 9.30 and 9.40 millimeters.

5. The theatrical wire rope hoist of claim 1, wherein the flanked surfaces of the mechanical coupling are each a prismatic approximation of a curve.

6. A mechanical coupling for use with a theatrical wire rope hoist, comprising:
a shaft including:
a body portion; and
a head portion defining an external hexagonal end with flanked surfaces in a plane parallel to and radial with a centerline of the mechanical coupling; and
a liner including an internal hexagonal end corresponding to the external hexagonal end of the shaft,
wherein the flanked surfaces of the external hexagonal end are configured to engage with the internal hexagonal end of the liner,
wherein the mechanical coupling enables transmission of a moment about an x-axis of the mechanical coupling and enables transmission of forces along a y-axis and a z-axis of the mechanical coupling, and
wherein the mechanical coupling inhibits transmission of moments about the y-axis and the z-axis of the mechanical coupling and inhibits transmission of forces along the z-axis of the mechanical coupling.

7. The mechanical coupling of claim 6, wherein moments about the y-axis and the z-axis enable sliding contact between the flanked surfaces of the external hexagonal end and the internal hexagonal end of the liner.

8. The mechanical coupling of claim 6, wherein the flanked surfaces each have a radius between about 9 and 10 millimeters.

9. The mechanical coupling of claim 6, wherein the flanked surfaces each have a radius between about 9.30 and 9.40 millimeters.

10. The theatrical wire rope hoist of claim 6, wherein the flanked surfaces are each a prismatic approximation of a curve.

11. The theatrical wire rope hoist of claim 6, wherein the body portion of the mechanical coupling includes a slotted relief surface on a surface parallel with a top plane of the body portion.

12. The theatrical wire rope hoist of claim 6, wherein the head portion of the mechanical coupling includes an O-ring groove that follows an outer contour of the external hexagonal end.

13. A mechanical coupling for use with a theatrical wire rope hoist, comprising:
a shaft including:
a body portion; and
a head portion defining an external hexagonal end with flanked surfaces in a plane parallel to and radial with a centerline of the mechanical coupling,
wherein the theatrical wire rope hoist includes a drum having an internal hexagonal end, and wherein the flanked surfaces of the external hexagonal end are configured to engage with the internal hexagonal end of the drum,
wherein the mechanical coupling enables transmission of a moment about an x-axis of the mechanical coupling thereby causing the drum to rotate, and enables transmission of forces along a y-axis and a z-axis of the mechanical coupling, and
wherein the mechanical coupling inhibits transmission of moments about the y-axis and the z-axis of the mechanical coupling and inhibits transmission of forces along the z-axis of the mechanical coupling.

14. The theatrical wire rope hoist of claim 13, wherein the flanked surfaces of the mechanical coupling each have a radius between about 9 and 10 millimeters.

15. The theatrical wire rope hoist of claim 13, wherein the flanked surfaces of the mechanical coupling each have a radius between about 9.30 and 9.40 millimeters.

16. The theatrical wire rope hoist of claim 13, wherein the flanked surfaces of the mechanical coupling are each a prismatic approximation of a curve.

17. A mechanical coupling for use with a theatrical wire rope hoist, comprising:
a head portion defining an external hexagonal end with flanked surfaces in a plane parallel to and radial with a centerline of the mechanical coupling; and
a liner including an internal hexagonal end configured to engage with the external hexagonal end of the head portion,
wherein the flanked surfaces of the external hexagonal end are configured to engage with the internal hexagonal end of the liner,
wherein the mechanical coupling enables transmission of a moment about an x-axis of the mechanical coupling and enables transmission of forces along a y-axis and a z-axis of the mechanical coupling, and
wherein the mechanical coupling inhibits transmission of moments about the y-axis and the z-axis of the mechanical coupling and inhibits transmission of forces along the z-axis of the mechanical coupling.

18. The theatrical wire rope hoist of claim 17, wherein the flanked surfaces of the mechanical coupling each have a radius between about 9 and 10 millimeters.

19. The theatrical wire rope hoist of claim 17, wherein the flanked surfaces of the mechanical coupling each have a radius between about 9.30 and 9.40 millimeters.

20. The theatrical wire rope hoist of claim 17, wherein the flanked surfaces of the mechanical coupling are each a prismatic approximation of a curve.
